(19) United States
(12) Patent Application Publication
(10) Pub. No.: US 2026/0210312 A1
(43) Pub. Date: Jul. 23, 2026

(54) IMPROVING THE DYNAMIC BEHAVIOR OF THE DRIVE SHAFT OF THE FAN ROTOR OF AN AERONAUTICAL PROPULSION SYSTEM

(71) Applicant: SAFRAN AIRCRAFT ENGINES, Paris (FR)

(72) Inventor: Didier René André ESCURE, MOISSY-CRAMAYEL (FR)

(73) Assignee: SAFRAN AIRCRAFT ENGINES, Paris (FR)

(21) Appl. No.: 19/141,554

(22) PCT Filed: Dec. 22, 2023
(86) PCT No.: PCT/FR2023/052096

§ 371 Date: Jun. 20, 2025

(30) Foreign Application Priority Data
Dec. 22, 2022 (FR) 2214339

(51) Int. Cl. F02K 3/02; F02C 7/36

(52) U.S. Cl. CPC F02K 3/02; F02C 7/36; F05D 2200/11; F05D 2200/13; F05D 2200/14; F05D 2200/211; F05D 2200/221; F05D 2220/323; F05D 2240/90

(57) ABSTRACT

An aeronautical propulsion system includes a first turbine that drives a first compressor via a first shaft, a second turbine that drives a second compressor via a second shaft that rotates at a higher speed than the first shaft, a fan rotor connected to a fan shaft, and a reduction structure coupling the first shaft and the fan shaft to drive the fan shaft at a rotation speed lower than the rotation speed of the first shaft. An average radius of a bore of the second turbine is based on an average radius of the bore of the second turbine, a thrust of the propulsion system, a bypass ratio of the propulsion system, and several constants.

### TECHNICAL FIELD

The present application generally relates to the field of propulsion systems, and more particularly to aeronautical propulsion systems having a high or even very high bypass ratio.

### BACKGROUND

A propulsion system generally includes, from upstream to downstream in the direction of gas flow, a fan section, a compressor section that may comprise a low-pressure compressor and a high-pressure compressor, a combustion chamber and a turbine section that may comprise in particular a high-pressure turbine and a low-pressure turbine. The high-pressure compressor is driven in rotation by the high-pressure turbine via a high-pressure shaft. The fan and, where applicable, the low-pressure compressor are driven in rotation by the low-pressure turbine via a low-pressure shaft.

Technological research efforts have already led to very significant improvements in the environmental performance of airplanes. The Applicant takes into account the factors that have an impact on all design and development phases to obtain less energy-intensive, more environmentally friendly aeronautical components and products, the integration and use of which in civil aviation have moderate environmental consequences, with the aim of improving the energy efficiency of airplanes.

Thus, in order to improve the propulsive efficiency of the propulsion system and reduce its specific consumption as well as the noise emitted by the fan section, propulsion systems with a high bypass ratio BPR (corresponding to the ratio between the flow rate of the secondary air stream and the flow rate of the primary air stream) have been proposed. To achieve such bypass ratios, the fan section can be decoupled from the low-pressure turbine, thus making it possible to independently optimize their respective rotation speed. Generally, the decoupling is achieved using a reduction mechanism placed between the upstream end of the low-pressure shaft and a rotor of the fan section. The rotor of the fan section is then driven by the low-pressure shaft via the reduction mechanism at a rotation speed lower than that of the low-pressure shaft.

The current trend is to increase the overall compression ratio of the propulsion system, which corresponds to the ratio between the outlet pressure of the high-pressure compressor and the inlet pressure of the fan. This indeed makes it possible to increase the inlet pressure of the combustion chamber gases, and therefore to further improve the overall efficiency of the propulsion system. The increase of the overall compression ratio therefore requires the increase of the compression ratio of the high-pressure compressor and/or of the low-pressure compressor, especially since it is sought at the same time to reduce the compression ratio of the fan for the reasons explained above.

One of the consequences is that the torque to be transmitted by the low-pressure shaft to the reduction mechanism is reduced compared to a direct-drive propulsion system. The low-pressure shaft can therefore have a smaller diameter, which facilitates the integration of the high-pressure spool into the propulsion system. However, this reduction in the diameter of the low-pressure shaft has the effect of reducing the frequency of the eigenmodes, while the increase of the rotation speed of the low-pressure shaft expands the operating range of the low-pressure shaft. As a result, the low-pressure shaft can exceed a critical speed and may enter into resonance. At resonance, which occurs when the low-pressure shaft passes the critical speed, this low-pressure shaft undergoes overvoltage phenomena that amplify the deformations and forces caused by the (inevitable) imbalances of the low-pressure shaft. Under these conditions, the low-pressure shaft is said to be supercritical.

Thus, the modification of the diameter of the low-pressure shaft has an impact on its dynamic behavior and modifies the positioning of its supercritical modes. However, a propulsion system rotating at a critical speed in steady state risks rapid degradation, which must be avoided.

### SUMMARY

One aim of the present application is to optimize the propulsion system in order to increase its efficiency while controlling the dynamic behavior of the fan rotor drive shaft.

To this end, according to a first aspect, there is proposed an aeronautical propulsion system comprising:
a first turbine configured to drive a first compressor via a first shaft about an axis of rotation;
a second turbine configured to drive a second compressor via a second shaft, the second shaft being configured to rotate at a higher speed than the first shaft about the axis of rotation;
a fan rotor connected to a fan shaft;
a reduction mechanism coupling the first shaft and the fan shaft in order to drive the fan shaft at a rotation speed lower than the rotation speed of the first shaft;
   wherein an average radius of a bore of the second turbine meets the following formula:

$${R}_{m \_ a} \leq I * FN * BPR * {10}^{- 4} + J$$

where: R_{m_a} is the average radius of the bore of the second turbine in millimeters (mm);
FN is the thrust of the propulsion system measured when the propulsion system is stationary in take-off rating in a standard atmosphere and at sea level and is expressed in Newton (N);
BPR is the bypass ratio of the propulsion system and is measured when the propulsion system is stationary in take-off rating in a standard atmosphere and at sea level; and
I=0.16 millimeters per Newton (mm/N) and J=28 millimeters.

Some preferred but non-limiting characteristics of the propulsion system according to the first aspect are the following, taken individually or in combination:
the average radius of the bore of the second turbine also meets the following formula:

$${R}_{m \_ a} \geq G * FN * BPR * {10}^{- 4} + H$$

where G=0.16 millimeters per Newton (mm/N) and H=18 millimeters (mm);
the average radius of the bore of the second turbine also meets the following formula:

$${R}_{m \_ a} \leq E * {L}_{HP}^{2} * XN * {10}^{- 9} + {F}_{1}$$

where: L_{HP} is a distance between an inlet of the second compressor and an outlet of the second turbine in millimeters (mm); E=3.15 (mm·rpm)⁻¹ and F₁=23 millimeters (mm); and XN is the redline speed of the first shaft, in revolutions per minute (rpm);
the average radius of a bore of the second turbine also meets the following formula:

$${R}_{m \_ a} \geq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{2}$$

where: L_{HP} is a distance between an inlet of the second compressor 5 and an outlet of the second turbine in millimeters (mm); E=3.15 (mm·rpm)⁻¹ and F₂=13 millimeters (mm); and XN is the redline speed of the first shaft, in revolutions per minute (rpm);
the average radius of a bore of the second turbine also meets the following formula:

$${R}_{m \_ a} \leq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{1}$$

where: D₉ is the diameter of the fan rotor in millimeters (mm), measured in a plane normal to the axis of rotation at an intersection between a tip and a leading edge of the blades of the fan rotor; BPR is the bypass ratio of the propulsion system and is measured when the propulsion system is stationary in take-off rating in a standard atmosphere and at sea level; Tₑ is the maximum inlet temperature of the drive turbine when the propulsion system is stationary in take-off rating in a standard atmosphere and at sea level and is expressed in degrees Celsius (° C.); T_{ref}=273 K; n is the number of stages in the second turbine and the second compressor; GAMMA is the adiabatic coefficient of air; XN is the redline speed of the first shaft, in revolutions per minute (rpm); and K=6.76, L=153.6 m⁻¹·(° C.)^{-1/2}·(rpm)⁻¹, M=421 mm·(° C.)^{1/2} and N₁=−11 millimeters (mm);
the average radius of a bore of the second turbine also meets the following formula:

$${R}_{m \_ a} \geq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{2}$$

where: D₉ is the diameter of the fan rotor in millimeters, measured in a plane normal to the axis of rotation at an intersection between a tip and a leading edge of the blades of the fan rotor; BPR is the bypass ratio of the propulsion system and is measured when the propulsion system is stationary in take-off rating in a standard atmosphere and at sea level; Tₑ is the maximum inlet temperature of the drive turbine when the propulsion system is stationary in take-off rating in a standard atmosphere and at sea level and is expressed in degrees Celsius (° C.); T_{ref}=273 K; n is the number of stages in the second turbine and the second compressor; GAMMA is the adiabatic coefficient of air; XN is the redline speed of the first shaft, in revolutions per minute (rpm); and K=6.76, L=153.6 m⁻¹·(° C.)−^{1/2}·(rpm)⁻¹, M=421 mm·(° C.)^{1/2} and N₂=−21 millimeters (mm);
a hub-to-tip ratio of the second turbine is comprised between 0.77 and 0.90;
the propulsion system further comprises bearings configured to center the first shaft relative to the axis of rotation, the bearings comprise a bearing mode damper;
the propulsion system further comprises an inter-turbine casing extending between the first turbine and the second turbine and configured to support the second turbine through a bearing assembly;
the inter-turbine casing comprises a plurality of guide vanes configured to straighten an air stream at the inlet of the first turbine;
the propulsion system comprises between twenty and thirty guide vanes.
an overall compression ratio of the propulsion system, corresponding to the ratio between an outlet pressure of the second compressor and an inlet pressure of the fan rotor, is greater than or equal to 40 and less than or equal to 70;
the second turbine is a two-stage turbine;
the second compressor comprises at least eight stages and at most eleven stages;
the bypass ratio of the propulsion system is greater than or equal to 10, for example comprised between 10 and 35 inclusive, for example between 10 and 18 inclusive, for example between 10 and 15 inclusive;
the first turbine comprises at least three stages and at most five stages; and/or
the first compressor comprises at least two stages and at most four stages.

According to a second aspect, there is proposed an aircraft comprising at least one propulsion system according to the first aspect, fixed to the aircraft via a mast.

According to a third aspect, there is proposed a method for dimensioning or manufacturing a propulsion system comprising a reduction mechanism coupling a first turbine and a fan rotor to drive the fan rotor at a lower speed than a speed of the first turbine, and a second turbine configured to rotate at a higher speed than the first turbine, the second turbine being dimensioned such that an average radius of a bore of the second turbine meets the following formula:

$${R}_{m \_ a} \leq I * FN * BPR * {10}^{- 4} + J$$

where: R_{m_a} is the average radius of the bore of the second turbine in millimeters;
FN is the thrust of the propulsion system measured when the propulsion system is stationary in take-off rating in a standard atmosphere and at sea level and is expressed in Newton (N);
BPR is the bypass ratio of the propulsion system and is measured when the propulsion system is stationary in take-off rating in a standard atmosphere and at sea level; and
I=0.16 millimeters per Newton (mm/N) and J=28 millimeters.

Some preferred but non-limiting characteristics of the dimensioning method according to the third aspect are the following, taken individually or in combination:
the second turbine is dimensioned so that the average radius of the bore of the second turbine is the average radius of the bore of the second turbine further meets the following formula:

$${R}_{m \_ a} \geq G * FN * BPR * {10}^{- 4} + H$$

where G=0.16 millimeters per Newton (mm/N) and H=18 millimeters (mm);
the second turbine is dimensioned so that the average radius of the bore of the second turbine also meets the following formula:

$${R}_{m \_ a} \leq E * {L}_{HP}^{2} * XN * {10}^{- 9} + {F}_{1}$$

where: L_{HP} is a distance between an inlet of the second compressor 5 and an outlet of the second turbine in millimeters (mm); E=3.15 (mm·rpm)⁻¹ and F₁=23 millimeters (mm); and XN is the redline speed of the first shaft, in revolutions per minute (rpm);
the second turbine is dimensioned such that the average radius of the bore of the second turbine also meets the following formula:

$${R}_{m \_ a} \geq E * {L}_{HP}^{2} * XN * {10}^{- 9} + {F}_{2}$$

where: L_{HP} is a distance between an inlet of the second compressor and an outlet of the second turbine in millimeters (mm); E=3.15 (mm·rpm)⁻¹ and F₂=13 millimeters (mm); and XN is the redline speed of the first shaft, in revolutions per minute (rpm);
the second turbine is dimensioned such that the average radius of the bore of the second turbine also meets the following formula:

$${R}_{m \_ a} \leq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{1}$$

where: D₉ is the diameter of the fan rotor in millimeters (mm), measured in a plane normal to the axis of rotation at an intersection between a tip and a leading edge of the blades of the fan rotor; BPR is the bypass ratio of the propulsion system and is measured when the propulsion system is stationary in take-off rating in a standard atmosphere and at sea level; Tₑ is the maximum inlet temperature of the drive turbine when the propulsion system is stationary in take-off rating in a standard atmosphere and at sea level and is expressed in degrees Celsius (° C.); T_{ref}=273K; n is the number of stages in the second turbine and the second compressor; GAMMA is the adiabatic coefficient of air; XN is the redline speed of the first shaft, in revolutions per minute (rpm); and K=6.76, L=153.6 m⁻¹·(° C.)^{-1/2}·(rpm)⁻¹, M=421 mm·(° C.)^{1/2} and N₁=−11 millimeters (mm);
the second turbine is dimensioned such that the average radius of the bore of the second turbine also meets the following formula:

$${R}_{m \_ a} \geq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{2}$$

where: D₉ is the diameter of the fan rotor in millimeters (mm), measured in a plane normal to the axis of rotation at an intersection between a tip and a leading edge of the blades of the fan rotor; BPR is the bypass ratio of the propulsion system and is measured when the propulsion system is stationary in take-off rating in a standard atmosphere and at sea level; Tₑ is the maximum inlet temperature of the drive turbine when the propulsion system is stationary in take-off rating in a standard atmosphere and at sea level and is expressed in degrees Celsius (° C.); T_{ref}=273 K; n is the number of stages in the second turbine and the second compressor; GAMMA is the adiabatic coefficient of air; XN is the redline speed of the first shaft, in revolutions per minute (rpm); and K=6.76, L=153.6 m⁻¹·(° C.)^{-1/2}·(rpm)⁻¹, M=421 mm·(° C.)^{1/2} and N₂=−21 millimeters (mm).

According to a fourth aspect, there is proposed a method for manufacturing a propulsion system comprising the following steps:
dimensioning the propulsion system in accordance with the method of the third aspect; and
manufacturing the propulsion system.

### DESCRIPTION OF THE FIGURES

Other characteristics, aims and advantages of the invention will emerge from the following description, which is purely illustrative and non-limiting, and which should be read in relation to the appended drawings, in which:

FIG. 1 is a schematic, partial and sectional view of one example of a propulsion system in accordance with one embodiment;

FIG. 2 is a schematic sectional view of one example of a reduction mechanism according to a first variant;

FIG. 3 is a schematic sectional view of one example of a reduction mechanism according to a second variant;

FIG. 4 is one example of an aircraft that may comprise at least one propulsion system in accordance with one embodiment; and

FIG. 5 is a flowchart illustrating examples of steps in a dimensioning or manufacturing method in accordance with one embodiment.

Throughout the figures, similar elements bear identical references.

### DETAILED DESCRIPTION

A propulsion system 1 has a main direction extending along a longitudinal axis X and comprises, from upstream to downstream in the direction of gas flow in the propulsion system 1 when in operation, a fan section 2 and a primary spool 3, often called “gas generator”, including a compressor section 4, 5, a combustion chamber 6 and a turbine section 7, 8. The propulsion system 1 is here an aeronautical propulsion system 1 configured to be fixed to an aircraft 100 via a pylon (or mast).

The compressor section 4, 5 comprises a succession of stages each comprising a blade wheel (rotor) 4a, 5a rotating in front of a vane wheel (stator) 4b, 5b. The turbine section 7, 8 also comprises a succession of stages, each comprising a vane wheel (stator) 7b, 8b, behind which a blade wheel (rotor) 7a, 8a rotates.

In the present application, the axial direction corresponds to the direction of the longitudinal axis X, in correspondence with the rotation of the gas generator shafts, and a radial direction is a direction perpendicular to this axis X and passing therethrough. Moreover, the circumferential (or lateral or tangential) direction corresponds to a direction perpendicular to the longitudinal axis X and not passing therethrough. Unless otherwise specified, the terms “inner” (respectively, internal) and “outer” (respectively, external), respectively, are used with reference to a radial direction so that the inner portion or face of an element is closer to the axis X than the outer portion or face of the same element.

In operation, an air stream F entering the propulsion system 1 is divided between a primary air stream F1 and a secondary air stream F2, which circulate from upstream to downstream in the propulsion system 1.

The secondary air stream F2 (also called “bypass air stream”) flows around the primary spool 3. The secondary air stream F2 cools the periphery of the primary spool 3 and serves to generate most of the thrust provided by the propulsion system 1.

The primary air stream F1 flows in a primary path inside the primary spool 3, passing successively through the compressor section 4, 5, the combustion chamber 6 where it is mixed with fuel to serve as an oxidizer, and the turbine section 7, 8. The passage of the primary air stream F1 through the turbine section 7, 8 receiving energy from the combustion chamber 6 causes rotation of the rotor of the turbine section 7, 8, which in turn drives in rotation the rotor of the compressor section 4, 5 as well as a rotor portion 9 of the fan section 2.

In a two-spool propulsion system 1, the compressor section 4, 5 may comprise a low-pressure compressor 4 and a high-pressure compressor 5. The turbine section 7, 8 may comprise a high-pressure turbine 7 and a low-pressure turbine 8. The rotor of the high-pressure compressor 5 is driven in rotation by the rotor of the high-pressure turbine 7 via a high-pressure shaft 10. The rotor of the low-pressure compressor 4 and the rotor portion 9 of the fan section 2 are driven in rotation by the rotor of the low-pressure turbine 8 via a low-pressure shaft 11. Thus, the primary spool 3 comprises a high-pressure spool comprising the high-pressure compressor 5, the high-pressure turbine 7 and the high-pressure shaft 10, and a low-pressure spool comprising the fan section 2, the low-pressure compressor 4, the low-pressure turbine 8 and the low-pressure shaft 11. The rotation speed of the high-pressure spool is greater than the rotation speed of the low-pressure spool. In a triple-spool propulsion system 1, the turbine section 7, 8 further comprises an intermediate turbine, positioned between the high-pressure turbine 7 and the low-pressure turbine 8 and configured to drive the rotor of the low-pressure compressor 4 via an intermediate shaft. The fan rotor 9 and the rotor of the high-pressure compressor 5 remain driven by the low-pressure shaft 11 and the high-pressure shaft 10, respectively.

The low-pressure shaft 11 is generally housed, over a part of its length, in the high-pressure shaft 10 and is coaxial with the high-pressure shaft 10. The low-pressure shaft 11 and the high-pressure shaft 10 may be co-rotating, that is to say driven in the same direction about the longitudinal axis X. As a variant, the low-pressure shaft 11 and the high-pressure shaft are counter-rotating, that is to say driven in opposite directions about the longitudinal axis X. Where appropriate, the intermediate shaft is housed between the high-pressure shaft 10 and the low-pressure shaft 11. The intermediate shaft and the low-pressure shaft 11 may be co-rotating or counter-rotating.

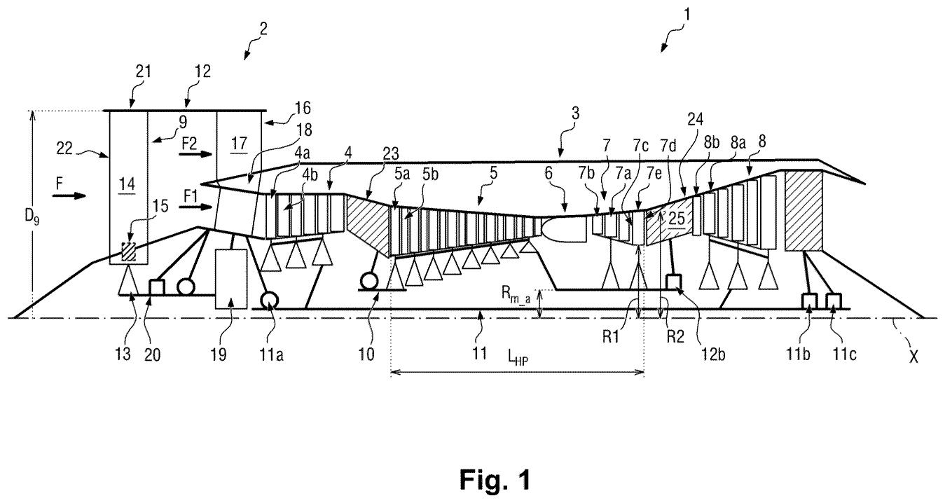

The fan section 2 comprises at least the fan rotor 9 capable of being driven in rotation relative to a fan casing 12 by the turbine section 7, 8. Each fan rotor 9 comprises a hub 13 and blades 14 extending radially from the hub 13. The blades 14 of each rotor 9 may be fixed relative to the hub 12 or have a variable setting. In this case, the root of the blades 14 of each rotor 9 is pivotally mounted along a setting axis and is connected to a pitch change mechanism 15 mounted in the propulsion system 1, the setting being adjusted according to the flight phases by a pitch change mechanism 15. The pitch change mechanism 15 is illustrated in broken lines in FIG. 1 to show that this characteristic is optional.

The fan section 2 may further comprise a fan stator 16, or straightener, which comprises vanes 17 mounted on a hub 18 of the fan stator 16 and have the function of straightening the secondary air stream F2 which flows at the outlet of the fan rotor 9. The vanes 17 of the fan stator 18 may be fixed relative to the hub 18 or have a variable setting.

In order to improve the propulsive efficiency of the propulsion system 1 and to reduce its specific consumption as well as the noise emitted by the fan section 2, the propulsion system 1 has a high bypass ratio. By high bypass ratio, it is meant here a bypass ratio greater than or equal to 10, for example comprised between 10 and 80 inclusive. To calculate the bypass ratio, the mass flow rate of the secondary air stream F2 and the mass flow rate of the primary air stream F1 are measured when the propulsion system 1 is stationary, uninstalled, in take-off rating in a standard atmosphere (as defined by the International Civil Aviation Organization (ICAO) manual, Doc 7488/3, 3^{rd} edition) and at sea level (conditions known as SLS, for Seal Level Standard). It should be noted that, in the present application, the parameters (pressure, flow rate, thrust, speed, etc.) are systematically determined under these conditions. By “uninstalled” it will be meant here that the measurements are performed when the propulsion system 1 is in a test bench (and uninstalled on an aircraft 100), the measurements then being simpler to make. The distances (length, radius, diameter) are however measured at room temperature (around 20° C.) when the propulsion system 1 is cold, that is to say when the propulsion system is stopped from a sufficient period for the parts of the propulsion system to be at room temperature.

The fan rotor 9 is decoupled from the low-pressure shaft 11 using a reduction mechanism 19, placed between an upstream end of the low-pressure shaft 11 and the fan rotor 9, in order to independently optimize their respective rotation speed. In this case, the propulsion system 1 further comprises an additional shaft, called fan shaft 20. The low-pressure shaft 11 connects the low-pressure turbine 8 to an inlet of the reduction mechanism 19 while the fan shaft 20 connects the outlet of the reduction mechanism 19 to the fan rotor 9. The fan rotor 9 is therefore driven by the low-pressure shaft 11 via the reduction mechanism 19 and the fan shaft 20 at a rotation speed lower than the rotation speed of the low-pressure turbine 8.

This decoupling makes it possible to reduce the rotation speed and the pressure ratio of the fan rotor 9 and to increase the power extracted by the low-pressure turbine 8. Indeed, the overall efficiency of the propulsion systems is conditioned to the first order by the propulsive efficiency, which is favorably influenced by minimizing the variation of the kinetic energy of the air at the crossing of the propulsion system 1. In a propulsion system 1 with a high bypass ratio, most of the flow rate generating the propulsive force is constituted by the secondary air stream F2 of the propulsion system 1, the kinetic energy of the secondary air stream F2 being mainly affected by the compression that the secondary air stream F2 undergoes during the crossing of the fan section 2. The propulsive efficiency and the pressure ratio of the fan section 2 are therefore linked: the lower the pressure ratio of the fan section 2, the better the propulsive efficiency. In order to optimize the propulsive efficiency of the propulsion system 1, the pressure ratio of the fan, which corresponds to the ratio between the average outlet pressure of the fan stator 17 (or, in the absence of a stator, of the fan rotor 9) and the average inlet pressure of the fan rotor 9, is less than or equal to 1.70, for example less than or equal to 1.50, for example comprised between 1.05 and 1.45. The average pressures are measured here over the height of the blade 14 (from the surface which radially delimits, inside, the flow path at the inlet of the fan rotor 9 to the tip 21 of the fan blade 14).

The propulsion system 1 is configured to provide a thrust comprised between 18,000 lbf (80,068 N) and 51,000 lbf (22 2411 N), for example between 20,000 lbf (88,964 N) and 35,000 lbf (15 5688 N).

The fan section 2 is ducted and to that end comprises a fan casing 12, the fan rotor 9 being housed in the fan casing 12.

The fan section 2 particularly comprises a fan rotor 9 extending upstream of a fan stator. The vanes of the fan stator are then generally referred to as outlet guide vanes (OGV) and have a fixed setting relative to the hub of the fan stator. Moreover, the bypass ratio of the propulsion system 1 is for example greater than or equal to 10, for example comprised between 10 and 35 inclusive, for example between 10 and 18 inclusive, for example between 10 and 15 inclusive. It should be noted that, when the bypass ratio is greater than or equal to 25, the fan rotor 9 is preferably a variable-setting fan rotor. The peripheral speed at the tip 21 of the blades of the fan rotor 9 may also be comprised between 260 m/s and 400 m/s. The blades 14 of the fan rotor 9 may be fixed or have a variable setting. The fan pressure ratio may be comprised between 1.20 and 1.45.

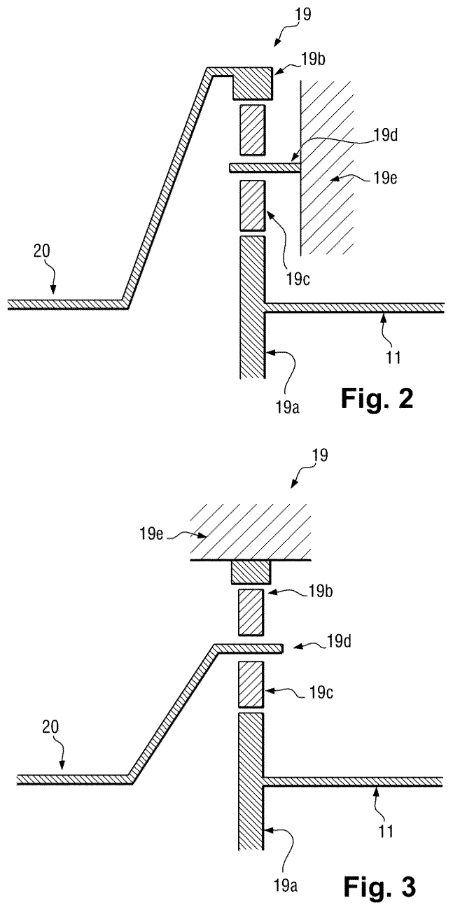

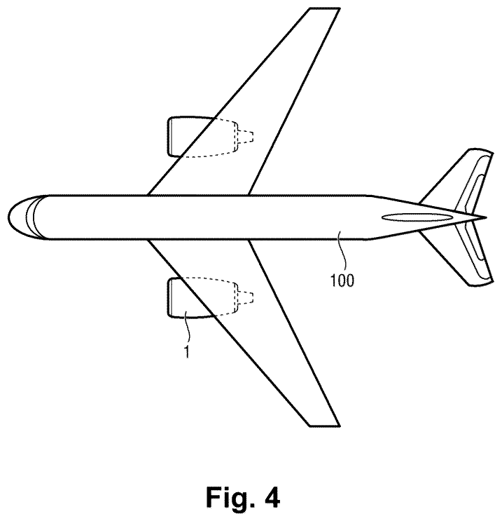

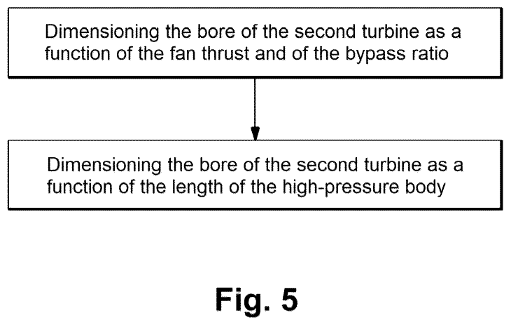

The reduction mechanism 19 may comprise a reduction mechanism 19, in this example a reduction mechanism with a planetary gear train, for example of the “planetary” or “star” type, according to the encountered terminology of those skilled in the art, single-staged or two-staged. According to a first variant, the reduction mechanism 19 may be of the star type (FIG. 2) and comprise a sun gear pinion 19a (inlet of the reduction mechanism 19), centered on an axis of rotation X of the reduction mechanism 19 (generally coincident with the longitudinal axis X) and configured to be driven in rotation by the low-pressure shaft 11, a ring gear 19b (outlet of the reduction mechanism 19) coaxial with the sun gear pinion 19a and configured to drive in rotation the fan shaft 20 about the axis of rotation X, and a series of planet gears 19c circumferentially distributed about the axis of rotation X between the sun gear pinion 19a and the ring gear 19b, each planet gear 19c being meshed internally with the sun gear pinion 19a and externally with the ring gear 19b. The series of planet gears 19c is mounted on a planet gear carrier 19d which is fixed relative to a stator portion 19e of the propulsion system 1, for example relative to a casing of the compressor section 4, 5. According to a second variant, the reduction mechanism 19 can be of the planetary type (FIG. 3), in which case the ring gear 19b is fixedly mounted on the stator portion 19e of the propulsion system 1 and the fan shaft 20 is driven in rotation by the planet gear carrier 19d (which is therefore movable in rotation relative to a stator portion 19e of the propulsion system 1, for example relative to a casing of the compressor section 4, 5).

Regardless of the configuration of the reduction mechanism 19, the diameter of the ring gear 19b and of the planet gear carrier 19d are greater than the diameter of the sun gear pinion 19a, such that the rotation speed of the fan rotor 9 is lower than the rotation speed of the low-pressure shaft 11.

The reduction ratio of the reduction mechanism 19 is greater than or equal to 2.5 and less than or equal to 11, for example greater than or equal to 2.7 and less than or equal to 6.0, for example around 3.0.

The decoupling of the low-pressure shaft 11 and of the fan rotor 9 by means of the reduction mechanism makes it possible to obtain an efficient propulsion system 1 whose fan pressure ratio is less than 1.45. Consequently, the amount of energy to drive the fan rotor 9 is reduced so that the flow rate at the inlet of the high-pressure compressor 5 and therefore the inlet section of the high-pressure compressor 5 can be reduced. This, however, has the consequence of limiting the space available for the low-pressure shaft 11 (since the low-pressure shaft 11 is housed within the high-pressure shaft 10). In addition, the reduction of the flow rate in the high-pressure compressor 5 also has the effect of reducing the flow rate in the low-pressure turbine, which makes it possible to increase the rotation speed of the low-pressure shaft 11 and to reduce the torque transmitted by the low-pressure shaft 11 and its diameter. However, the reduction of the diameter of the low-pressure shaft 1 requires optimizing the dynamic behavior of the low-pressure shaft 11 to prevent it from becoming more supercritical.

In order to optimize the propulsion system 1 while controlling the dynamic behavior of the low-pressure shaft 11, the propulsion system 11 is dimensioned so that the average radius R_{m_a} of a bore of the high-pressure turbine 7 is at most equal to:

$${R}_{m \_ a} \leq I * FN * BPR * {10}^{- 4} + J \qquad ( 1 )$$

where: R_{m_a} is expressed in millimeters (mm);
FN is the thrust of the propulsion system, in Newton (N);
BPR is the bypass ratio of the propulsion system 1; and
I=0.16 millimeters per Newton (mm/N) and J=28 millimeters (mm).

Indeed, the torque transmitted by the low-pressure shaft 11 to the fan rotor 9 is linked to the thrust of the fan rotor 9 and to the bypass ratio BPR of the propulsion system 1. Moreover, the increase of the bypass ratio BPR of the propulsion system 1 makes it possible to reduce the diameter of the high-pressure spool, and therefore of the average radius R_{m_a} of the bore of the high-pressure turbine 7. Thus, by dimensioning the propulsion system so that the average radius R_{m_a} of the bore of the high-pressure turbine 7 also meets the formula (2), a propulsion system 1 is obtained in which the size of the high-pressure spool and the diameter of the low-pressure shaft 11 are dimensioned as a function of the thrust of the fan rotor 9 (which contributes mainly to the overall thrust of the propulsion system 1) and of the bypass ratio BPR.

The average radius R_{m_a} of the bore of the high-pressure turbine 7 corresponds to the distance, measured in a plane normal to the longitudinal axis X midway between the leading edge 7c and the trailing edge 7d of the blades of the most upstream rotor 7a of the high-pressure turbine 7 (that is to say of the rotor 7a of the first stage of the high-pressure turbine 7), between the bore of the disk of the rotor 7a of the high-pressure turbine 7 and the axis of rotation X. The bore here corresponds to the radially inner face of the disk of the rotor 7a.

For example, the average radius R_{m_a} of the bore of each disk of the high-pressure turbine 7 meets the formula (1).

For example, the average radius of the bore of the high-pressure turbine is at most equal to 300 mm.

A propulsion system 1 whose average radius R_{m_a} of the bore of the high-pressure turbine 7 meets the formula (1) can then achieve an overall compression ratio, which corresponds to the pressure ratio between the outlet pressure of the high-pressure compressor 5 and the inlet pressure of the fan rotor 9 (measured at the root of the fan rotor 9), be greater than or equal to 40 and less than or equal to 70, for example greater than or equal to 44 and less than or equal to 55.

The rotation speed of the high-pressure turbine 7 can then be comprised between 15,000 revolutions per minute and 27,000 revolutions per minute. When the rotation speed of the high-pressure turbine (and therefore of the high-pressure shaft 10) is within this range and when its average radius R_{m_a} meets the formula (1), the mechanical loading of the rotors 7a is acceptable for the high-pressure turbine 7.

For example, the propulsion system 1 is further dimensioned so that the average radius R_{m_a} of the bore of the high-pressure turbine 7 is at most equal to:

$${R}_{m \_ a} \leq E * {L}_{HP}^{2} * XN * {10}^{- 9} + {F}_{1} \qquad ( 2 )$$

where: L_{HP} is the length of the high-pressure spool, in millimeters (mm);
E=3.15 (mm·rpm)⁻¹ and F₁=23 millimeters (mm); and
XN is the redline speed of the low-pressure shaft 11, in revolutions per minute (rpm), which corresponds to the absolute maximum speed likely to be encountered by the low-pressure shaft 11 during the entire flight (according to the European certification regulation EASA CS-E 740 (or according to the American certification regulation 14-CFR Part 33.87). The redline speed corresponds to the maximum rotation speed when the propulsion system is sound (and potentially at the end of its life). It is therefore likely to be reached by the low-pressure shaft 11 in flight conditions. This redline speed forms part of the data declared in the engine certification (type certificate data sheet). Indeed, this rotation speed is usually used as a reference speed for the dimensioning of the propulsion systems 1 and in some certification tests (such as blade loss or rotor integrity tests).

The length L_{HP} of the high-pressure spool corresponds to the distance between an inlet of the high-pressure compressor 5 and an outlet of the high-pressure turbine 7. The inlet of the high-pressure compressor 5 corresponds to the most upstream portion of the most upstream blade wheel 5b (rotor) of the high-pressure compressor 5 (that is to say generally the leading edge 5c at the blade root of the first stage of the high-pressure compressor 5). The outlet of the high-pressure turbine 7 corresponds to the most downstream portion of the blade wheel 7a (rotor) of the high-pressure turbine 7 (that is to say generally the trailing edge 7d at the blade root of the last stage of the high-pressure turbine 7).

The length L_{HP} of the high-pressure spool may for example be comprised between 950 mm and 1,450 mm for a high-pressure spool comprising between ten and thirteen compressor and turbine stages.

The average radius R_{m_a} of a high-pressure turbine bore 7 also meets the following formula, particularly when the fan section 2 is ducted:

$${R}_{m \_ a} \geq E * {L}_{HP}^{2} * XN * {10}^{- 9} + {F}_{2} \qquad ( 3 )$$

where: F₂=13 millimeters (mm).

The dimensioning of the average radius of the bore so as to meet the formula (3) ensures a minimum radius for the high-pressure turbine and therefore guarantees its ability to withstand the centrifugal forces.

Since the low-pressure shaft 11 is housed in the high-pressure shaft 10, its diameter is constrained by the average radius R_{m_a} of the bore of the high-pressure turbine 7. However, the larger the diameter of the low-pressure shaft 11, the more its eigenmodes appear at high rotation speeds (or, in other words, the more the deformation modes of the shaft are shifted towards the high frequencies). The formula (1) thus makes it possible to reach a compromise between a small-diameter average bore radius of the high-pressure turbine 7—which makes it possible to improve the overall compression ratio of the propulsion system and its bypass ratio BPR—while controlling the dynamic situation of the low-pressure shaft 11.

Indeed, the deformation frequency of the low-pressure shaft 11 is proportional to the ratio between the diameter of the low-pressure shaft 11 and to the squared distance between the bearings 11a-11c of the low-pressure shaft 11. Thus, the further apart the bearings 11a-11c supporting the low-pressure shaft 11 are, the lower the deformation frequency (and therefore the deformation modes) of the low-pressure shaft 11. However, the position of the bearings 11a-11c of the low-pressure shaft 11 depends on the length L_{HP} of the high-pressure spool. By defining the average radius R_{m_a} of the bore of the high-pressure turbine 7 as a function of the length L_{HP} of the high-pressure spool (which is formed of the high-pressure compressor 5 and of the high-pressure turbine 7), the dynamic behavior of the low-pressure shaft 11 can therefore be better controlled.

Note that the redline speed XN is comprised between 8,500 revolutions per minute and 12,000 revolutions per minute, for example between 9,000 revolutions per minute and 11,000 revolutions per minute.

For example, the average radius R_{m_a} of the bore of each disk of the high-pressure turbine 7 meets the formula (2).

In some cases, the average radius R_{m_a} of the bore of the high-pressure turbine 7 is dimensioned before being able to determine the length L_{HP} of the high-pressure spool. In this case, the average radius of the bore can be determined from the fundamental dimensioning parameters which are the diameter Dg of the fan rotor 9, the bypass ratio BPR of the propulsion system 1 or the redline speed XN of the low-pressure shaft 11, rather than the length of the high-pressure spool (as defined in formulas (5) and (6)):

$${R}_{m \_ a} \leq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{1} \qquad ( 4 )$$

where: BPR is the bypass ratio of the propulsion system 1;
D₉ is the diameter of the fan rotor 9 in millimeters (mm), measured in a plane normal to the axis of rotation X at an intersection between a tip 21 and a leading edge 22 of the blades 14 of the fan rotor 9. It should be noted that since FIG. 1 is a partial view, the diameter D₉ is only partially visible;
Tₑ is the maximum inlet temperature of the low-pressure turbine 8, in degrees Celsius;

$${T}_{ref} = 273 K ;$$

n is the number of stages in the second turbine 7 and the second compressor 5;
GAMMA is the adiabatic coefficient of air; and
K=6.76, L=153.6 m⁻¹·(° C.)^{-1/2}·(rpm)⁻¹, M=421 mm·(° C.)^{1/2} and N₁=−11 millimeters (mm).

As specified for the formula (6), when the average radius R_{m_a} of the bore of the high-pressure turbine 7 meets the formula (7), the dynamic behavior of the low-pressure shaft 11 can therefore be better controlled.

Preferably, the average radius R_{m_a} of the bore of each disk of the high-pressure turbine 7 meets the formula (4).

The inlet temperature Tₑ of the low-pressure turbine 8 can be comprised between 950° C. and 1,230° C.

In addition, the average radius of the bore also meets the following formula:

$${R}_{m \_ a} \geq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{2} \qquad ( 5 )$$

where: N₂=−21 millimeters (mm).

Preferably, the average radius R_{m_a} of the bore of each disk of the high-pressure turbine 7 meets the formula (5).

In one embodiment, in order to maintain the possibility of introducing and passing the low-pressure shaft 11 into the high-pressure shaft 10, while guaranteeing the ability of the low-pressure shaft 11 to transmit the torque necessary for the fan rotor 9 and the low-pressure compressor 4, the average radius R_{m_a} of the bore of the second turbine 7 is at least equal to:

$${R}_{m \_ a} \geq G * FN * BPR * {10}^{- 4} + H \qquad ( 6 )$$

where: G=0.16 millimeters per Newton (mm/N) and H=18 millimeters (mm).

For example, the average radius R_{m_a} of the bore of each disk of the high-pressure turbine 7 meets the formula (6).

The Applicant also noticed that the position of the bearings 11a-11c of the low-pressure shaft 11 could also have an influence on the deformation modes of the low-pressure shaft 11. In this case, the low-pressure shaft 11 is supported by three or four bearings 11a, 11b and/or 11c, in order to better control the deformation modes of the low-pressure shaft 1 and possibly shift the deformation modes of the low-pressure shaft 11 in transient state of the propulsion system 1, with safety margins compared to steady states.

The low-pressure shaft may thus comprise one or two front bearings 11a and two rear bearings 11b, 11c. A first front bearing 11a is mounted on the one hand on the low-pressure shaft 11 and on the other hand on an inlet casing 26 of the propulsion system 1, which extends between the fan rotor 9 and the low-pressure compressor 4. If necessary, a second front bearing can be mounted on the one hand on the low-pressure shaft 11 and on the other hand on an inter-compressor casing 23 (or intermediate casing) of the propulsion system 1, i.e. between the low-pressure compressor 4 and the high-pressure compressor 5. A first rear bearing 11b can be mounted on the one hand on the low-pressure shaft 11 and on the other hand on the inter-turbine casing 24 (that is to say on the casing extending between the high-pressure turbine 7 and the low-pressure turbine 8), upstream of the low-pressure turbine 8. As a variant, the first rear bearing 11b can be mounted on the exhaust casing 27, which extends immediately downstream of the low-pressure turbine 8. The first rear bearing 11b extends downstream of the most downstream bearing 12b of the high-pressure shaft 10. The second rear bearing 11c may be mounted on the exhaust casing 27. If necessary, the first and second rear bearings 11b, 11c may be mounted on the same cylindrical shroud, which is itself fixed to the exhaust casing 27.

The inlet casing 26, the intermediate casing 23, the exhaust casing 27 and, if necessary, the inter-turbine casing 24 form structural casings of the propulsion system 1 through which the forces generated by the propulsion system pass 1.

High-pressure turbines 7 meeting the formula (1) may then have a hub-to-tip ratio, which corresponds to the ratio between an outer radius R2 of the high-pressure turbine 7 and an inner radius R1 of the rotor 7a (blade wheels) of the high-pressure turbine 7, greater than 0.77 and less than 0.90. The outer radius R2 of the high-pressure turbine 7 and the inner radius R1 are measured here in a plane normal to the axis of rotation X midway between the leading edge 7c and the trailing edge 7d of the blades of the rotor 7a at the hub (that is to say at 50% of the chord at the blade root) of the most downstream rotor 7a of the high-pressure turbine 7 (that is to say the last stage of the high-pressure turbine 7). The outer radius R2 of the high-pressure turbine 7 corresponds to the distance, in this plane, between the tip 7e of the blades of the rotor 7a of the high-pressure turbine 7 and the axis of rotation X of the high-pressure turbine 7. The inner radius R1 of the rotor 7a corresponds to the distance, in a plane normal to the axis of rotation X of the high-pressure turbine 7, between the outer radial surface of the hub of the rotor 7a (which radially delimits, inside, the flow path in the rotor 7a) and the axis of rotation X, midway between the leading edge 7c and the trailing edge 7d of the blades of the rotor 7a at the hub (at 50% of the chord at the blade root).

Such high-pressure turbines 7 then have an optimized outlet section Ss. Indeed, the smaller the hub-to-tip ratio, the smaller the outer diameter of the high-pressure turbine 7 (for the same section). A hub-to-tip ratio comprised between 0.77 and 0.90, in combination with optimized average radius R_{m_a} of the reduced bore (meeting the formula (1) and rotation speed as described above, thus makes it possible to obtain not only a more efficient high-pressure turbine 7 (due to its adapted rotation speed), in a suitable footprint, while also optimizing the outlet surface that expands the gases at the outlet of the combustion chamber 5. The dimensioning of the high-pressure turbine 7 so as to obtain a hub-to-tip ratio comprised between 0.77 and 0.90 therefore makes the high-pressure turbine 7 more efficient, and thus reduces the specific consumption of the propulsion system 1, without penalizing the dynamic behavior of the low-pressure shaft 11.

In order to further improve the control of the super-criticality of the low-pressure shaft 11, the bearings 11a-11c of the low-pressure shaft 11 comprise a bearing mode damper comprising a pressurized oil film configured to dampen the mode switch (viscous damping). This type of damping is generally known as “squeeze film”.

In addition, the propulsion system 1 further comprises an inter-turbine casing 24 extending between the high-pressure turbine 7 and the low-pressure turbine 8. The inter-turbine casing delimits the flow path between the high-pressure turbine 7 and the low-pressure turbine 8 and comprises guide vanes 25 configured to straighten an air stream exiting the high-pressure turbine 7 and thus improve the supply of the low-pressure turbine 8 and therefore the efficiency of the low-pressure spool. The guide vanes 25 therefore have an aerodynamic surface configured to reorient the air stream entering the low-pressure turbine 8. In one embodiment, the propulsion system 1 comprises between twenty and thirty guide vanes 25.

If necessary, the inter-turbine casing 24 forms a structural casing of the propulsion system 1 making it possible to improve the overall dynamics of the propulsion system 1. For this purpose, the inter-turbine casing comprises an inner shroud mounted on a set of bearings of the propulsion system 1, typically a rear bearing 26 of the high-pressure shaft, an outer shroud which can be configured to take up the mechanical forces in the propulsion system 1, as well as a series of arms extending radially between the inner shroud and the outer shroud and configured to allow the passage of ancillaries and the take-up of the mechanical forces between the inner shroud and the outer shroud. The guide vanes 25 may be distinct from the arms and extend between the arms and the low-pressure turbine 8.

### Comparative Example

Engine 1 is a two-spool propulsion system comprising a ducted fan and corresponding to the current technical standard (at the filing date of the present application) sought to be improved.

Engine 2 is a two-spool propulsion system comprising a ducted fan conforming to the teaching of the present application and has an average bore radius that meets the formula (1).

| | | Engine 2 |
|---|---|---|
| | | (consistent with the |
| | Engine 1 | disclosure of the |
| Dimensioning parameter (SLS) | (reference engine) | present application) |
| Thrust of the propulsion system | 158,803 N | 152,038 N |
| (FN) | | |
| Bypass ratio (BPR) | 11 | 12 |
| G * FN * BPR * 10⁻⁴ + H | 45.9 mm | 47.1 mm |
| I * FN * BPR * 10⁻⁴ + J | 55.9 mm | 57.1 mm |
| Average radius of the bore of the 1^{st} | 78.2 mm | 54.6 mm |
| stage of the second turbine (Rₘ_a) | | |
| Average radius of the bore of the | 78.2 mm | 54.6 mm |
| 2^{nd} stage of the second turbine | | |
| (Rₘ_a) | | |
| Diameter (D_{g}) | 2,108 mm (83 in.) | 2,057.4 mm (81 in.) |
| Inlet temperature of the low- | 1,02° C. | 1,027° C. |
| pressure turbine (Tₑ) | | |
| Number of stages of the high- | 12 | 11 |
| pressure spool (n) | | |
| Redline speed of the low-pressure | 8,962 rpm | 9,541.0 rpm |
| shaft 11 (XN) | | |
| Rₘ_a_MIN | 63 mm | 53.1 mm |
| Rₘ_a_MAX | 73 mm | 63.1 mm |
| L_{HP} | 1,190 mm | 1,083.6 mm |
| E * L_{Hp}² * XN * 10⁻⁹ + F₁ | 63 mm | 58.28 mm |
| E * L_{Hp}² * XN * 10⁻⁹ + F₂ | 53 mm | 48.28 mm |
| Hub-to-tip ratio of the high-pressure | 0.86 | 0.87 |
| turbine (1^{st} stage) | | |
| Hub-to-tip ratio of the high-pressure | 0.77 | 0.79 |
| turbine (2^{nd} stage) | | |
| Overall compression ratio | 42 | 42 |
| Number of stages of the low- | 2 | 2 |
| pressure compressor | | |
| Number of stages of the high- | 10 | 9 |
| pressure compressor | | |
| Number of stages of the high- | 2 | 2 |
| pressure turbine | | |
| Number of stages of the low- | 4 | 3 |
| pressure turbine | | |
| Reduction ratio | 2.73 | 2.88 |
| Redline speed of the fan rotor | 3,284 rpm | 3,316 rpm |
| Redline speed of the high-pressure | 19,888 rpm | 21,178 rpm |
| shaft (V_{HP}) | | |
| Fan Pressure ratio (FPR) | 1.43 | 1.44 |
| Compression ratio of high-pressure | 22.7 | 22.7 |
| compressor | | |
| Inlet temperature of the high- | 1,577° C. | 1,577° C. |
| pressure turbine | | |
| V_{HP}²S | 39.70 (rpm)²m² | 39.70 (rpm)²m² |
| (where S is the outlet section of the | | |
| high-pressure turbine) | | |

The dynamic situation of the low-pressure shaft of the engine 1 is subcritical. The engine 1 also has an average bore radius R_{m_a} smaller than the minimum average bore radius R_{m_a_MIN} as defined in the formula (1), while the engine 2 has an average bore radius R_{m_a} in accordance with the formula (1). As a result, the engine 2 is more compact than the engine 1 with a higher bypass ratio, a reduced number of stages and a dynamic situation of the low-pressure shaft of the engine 2 which is supercritical. This dynamic situation can however be controlled by the introduction of flexible cages and viscous vibration dampers on all or part of the bearings of the low-pressure shaft (in particular the most upstream bearing). Moreover, an optimization of the positioning of the path of the high-pressure spool, associated with an improvement of the cooling efficiency of the high-pressure turbine blades and improved active control of the clearances at the blade tip in the high-pressure turbine, in particular allows for the passage from 10 to 9 stages in the high-pressure compressor.

The reduction of the number of stages (passage from 4 to 3 stages) in the low-pressure turbine is also associated with an increase of the reduction ratio of the reduction mechanism and with an increase of the rotation speed of the fan rotor. Maintaining the compactness of the reduction mechanism is enabled by the improvement of the materials, for example, the use of ceramic rolling elements (bearings).

The expected gain for the engine 2 compared to the engine 1 is a reduced consumption installed on airplanes due to reduced friction drag (diameter reduced of the fan rotor and reduced length of the engine) and to reduced mass.

1. A propulsion system comprising:
a first turbine configured to drive a first compressor via a first shaft about an axis of rotation;
a second turbine configured to drive a second compressor via a second shaft, the second shaft being configured to rotate at a higher speed than the first shaft about the axis of rotation;
a fan rotor connected to a fan shaft;
a reduction structure coupling the first shaft and the fan shaft in order to drive the fan shaft at a rotation speed lower than the rotation speed of the first shaft;
wherein an average radius of a bore of the second turbine meets the following formula:
$$G * FN * BPR * {10}^{- 4} + H \leq {R}_{{m}_{a}} \leq I * FN * BPR * {10}^{- 4} + J$$
where:
R_{m_a} is the average radius of the bore of the second turbine in millimeters (mm);
FN is a thrust of the propulsion system measured when the propulsion system is stationary in take-off rating in a standard atmosphere and at sea level and is expressed in Newton (N);
BPR is a bypass ratio of the propulsion system and is measured when the propulsion system is stationary in take-off rating in a standard atmosphere and at sea level; and
G=0.16 millimeters per Newton, H=18 millimeters, I=0.16 millimeters per Newton and J=28 millimeters.

2. The propulsion system according to claim 1, wherein the average radius of the bore of the second turbine also meets the following formula:
$${R}_{{m}_{a}} \leq E * {L}_{HP}^{2} * XN * {10}^{- 9} + {F}_{1}$$
where:
L_{HP} is a distance between an inlet of the second compressor and an outlet of the second turbine in millimeters;
E=3.15⁻¹ and F₁=23 millimeters; and
XN is a redline speed of the first shaft, in revolutions per minute.

3. The propulsion system according to claim 1, wherein the average radius of the bore of the second turbine also meets the following formula:
$${R}_{{m}_{a}} \geq E * {L}_{HP}^{2} * XN * {10}^{- 9} + {F}_{2}$$
where:
L_{HP} is a distance between an inlet of the second compressor and an outlet of the second turbine in millimeters;
E=3.15⁻¹ and F₂=13 millimeters; and
XN is a redline speed of the first shaft, in revolutions per minute.

4. The propulsion system according to claim 1, wherein the average radius of the bore of the second turbine further meets the following formula:
$${R}_{{m}_{a}} \leq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{1}$$
where:
D₉ is a diameter of the fan rotor in millimeters, measured in a plane normal to the axis of rotation at an intersection between a tip and a leading edge of blades of the fan rotor;
Tₑ is a maximum inlet temperature of the first turbine when the propulsion system is stationary in take-off rating in a standard atmosphere and at sea level and is expressed in degrees Celsius;
$${T}_{ref} = 273 K ;$$
n is a number of stages in the second turbine and the second compressor;
GAMMA is an adiabatic coefficient of air;
XN is a redline speed of the first shaft, in revolutions per minute; and
K=6.76, L=153.6 m⁻¹·(° C.)^{-1/2}·(rpm)⁻¹, M=421 mm·(° C.)^{1/2} and N₁=−11 millimeters.

5. The propulsion system according to claim 1, wherein the average radius of the bore of the second turbine also meets the following formula:
$${R}_{m \_ a} \geq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{2}$$
where:
D₉ is a diameter of the fan rotor in millimeters, measured in a plane normal to the axis of rotation at an intersection between a tip and a leading edge of blades of the fan rotor;
Tₑ is a maximum inlet temperature of the first turbine when the propulsion system is stationary in take-off rating in a standard atmosphere and at sea level and is expressed in degrees Celsius;
$${T}_{ref} = 273 K ;$$
n is a number of stages in the second turbine and the second compressor;
GAMMA is an adiabatic coefficient of air;
XN is a redline speed of the first shaft, in revolutions per minute; and
K=6.76, L=153.6 m⁻¹·(° C.)^{-1/2}·(rpm)⁻¹, M=421 mm·(° C.)^{1/2} and N₂=−21 millimeters.

6. The propulsion system according to claim 1, wherein a hub-to-tip ratio of the second turbine is comprised between 0.77 and 0.90.

7. The propulsion system according to claim 1, further comprising bearings configured to center the first shaft relative to the axis of rotation, the bearings comprising a bearing mode damper.

8. The propulsion system according to claim 1, further comprising an inter-turbine casing extending between the first turbine and the second turbine and configured to support the second turbine through a bearing assembly.

9. The propulsion system according to claim 8, wherein the inter-turbine casing comprises a plurality of guide vanes configured to straighten an air stream at an inlet of the first turbine.

10. The propulsion system according to claim 9, comprising between twenty and thirty guide vanes.

11. The propulsion system according to claim 1, wherein an overall compression ratio of the propulsion system, corresponding to a ratio between an outlet pressure of the second compressor and an inlet pressure of the fan rotor, is greater than or equal to 40 and less than or equal to 70.

12. The propulsion system according to claim 1, wherein the second turbine is a two-stage turbine.

13. The propulsion system according to claim 1, wherein the second compressor comprises at least eight stages and at most eleven stages.

14. The propulsion system according to claim 1, wherein the bypass ratio of the propulsion system is greater than or equal to 10.

15. The propulsion system according to claim 1, wherein the first turbine comprises at least three stages and at most five stages.

16. The propulsion system according to claim 1, wherein the first compressor comprises at least two stages and at most four stages.

17. An aircraft comprising:
at least one of the propulsion system according to claim 1; and
a mast,
wherein the at least one of the propulsion system is fixed to the aircraft via the mast.

18. A method for operating a propulsion system comprising a reduction structure coupling a first turbine and a fan rotor to drive the fan rotor at a lower speed than a speed of the first turbine, and a second turbine configured to rotate at a higher speed than the first turbine, the second turbine being dimensioned such that an average radius of a bore of the second turbine meets the following formula:
$$G * FN * BPR * {10}^{- 4} + H \leq {R}_{{m}_{a}} \leq I * FN * BPR * {10}^{- 4} + J$$
where:
R_{m_a} is the average radius of the bore of the second turbine in millimeters;
FN is a thrust of the propulsion system measured when the propulsion system is stationary in take-off rating in a standard atmosphere and at sea level and is expressed in Newton;
BPR is a bypass ratio of the propulsion system and is measured when the propulsion system is stationary in take-off rating in a standard atmosphere and at sea level; and
G=0.16 millimeters per Newton, H=18 millimeters, I=0.16 millimeters per Newton and J=28 millimeters,
wherein the method comprises operating the propulsion system having the second turbine that has been dimensioned.

19. The method according to claim 18, wherein the second turbine is dimensioned so that the average radius of the bore of the second turbine also meets the following formula:
$${R}_{{m}_{a}} \leq E * {L}_{HP}^{2} * XN * {10}^{- 9} + {F}_{1}$$
where:
L_{HP} is a distance between an inlet of a second compressor and an outlet of the second turbine in millimeters;
E=3.15⁻¹ and F₁=23 millimeters; and
XN is a redline speed of a first shaft, in revolutions per minute.

20. The method according to claim 18, wherein the second turbine is dimensioned such that the average radius of the bore of the second turbine also meets the following formula:
$${R}_{{m}_{a}} \geq E * {L}_{HP}^{2} * XN * {10}^{- 9} + {F}_{2}$$
where:
L_{HP} is a distance between an inlet of a second compressor and an outlet of the second turbine in millimeters;
E=3.15⁻¹ and F₂=13 millimeters; and
XN is a redline speed of a first shaft, in revolutions per minute.

21. The method according to claim 18, wherein the second turbine is dimensioned such that the average radius of the bore of the second turbine also meets the following formula:
$${R}_{{m}_{a}} \leq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{1}$$
where:
D₉ is a diameter of the fan rotor in millimeters, measured in a plane normal to an axis of rotation at an intersection between a tip and a leading edge of blades of the fan rotor;
Tₑ is a maximum inlet temperature of the first turbine when the propulsion system is stationary in take-off rating in a standard atmosphere and at sea level and is expressed in degrees Celsius;
$${T}_{ref} = 273 K ;$$
n is a number of stages in the second turbine and a second compressor;
GAMMA is an adiabatic coefficient of air;
XN is a redline speed of a first shaft, in revolutions per minute; and
K=6.76, L=153.6 m⁻¹·(° C.)^{-1/2}·(rpm)⁻¹, M=421 mm·(° C.)^{1/2} and N₁=−11 millimeters.

22. The method according to claim 18, wherein the second turbine is dimensioned such that the average radius of the bore of the second turbine also meets the following formula:
$${R}_{m \_ a} \geq K * {( L * \sqrt{\frac{{D}_{9}^{2}}{BPR + 1} * {( {T}_{e} + {T}_{ref} )}^{0.5 - \frac{GAMMA}{GAMMA - 1}} * {10}^{3}} * n + M )}^{2} * XN * {10}^{- 9} + {N}_{2}$$
where:
D₉ is a diameter of the fan rotor in millimeters, measured in a plane normal to an axis of rotation at an intersection between a tip and a leading edge of blades of the fan rotor;
Tₑ is a maximum inlet temperature of the first turbine when the propulsion system is stationary in take-off rating in a standard atmosphere and at sea level and is expressed in degrees Celsius;
$${T}_{ref} = 273 K ;$$
n is a number of stages in the second turbine and a second compressor;
GAMMA is an adiabatic coefficient of air;
XN is a redline speed of a first shaft, in revolutions per minute; and
K=6.76, L=153.6 m⁻¹·(° C.)^{-1/2}·(rpm)⁻¹, M=421 mm·(° C.)^{1/2} and N₂=−21 millimeters.

23. A method for manufacturing a propulsion system comprising:
dimensioning the propulsion system comprising a reduction structure coupling a first turbine and a fan rotor to drive the fan rotor at a lower speed than a speed of the first turbine, and a second turbine configured to rotate at a higher speed than the first turbine, the second turbine being dimensioned such that an average radius of a bore of the second turbine meets the following formula:
$$G * FN * BPR * {10}^{- 4} + H \leq {R}_{{m}_{a}} \leq I * FN * BPR * {10}^{- 4} + J$$
where:
Rm_a is the average radius of the bore of the second turbine in millimeters;
FN is a thrust of the propulsion system measured when the propulsion system is stationary in take-off rating in a standard atmosphere and at sea level and is expressed in Newton;
BPR is a bypass ratio of the propulsion system and is measured when the propulsion system is stationary in take-off rating in a standard atmosphere and at sea level; and
G=0.16 millimeters per Newton, H=18 millimeters, I=0.16 millimeters per Newton and J=28 millimeters; and
manufacturing the propulsion system.
